(19) United States
(12) Patent Application Publication
(10) Pub. No.: US 2005/0251674 A1
(43) Pub. Date: Nov. 10, 2005

(54) Method and system for automatically initializing SATA controller

(75) Inventors: Po-Chang Wang, Tu-Cheng (TW); Huang-Nien Lin, Tu-Cheng (TW); Wei-Yuan Chen, Tu-Cheng (TW); Tai-Chen Wang, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/106,767

(22) Filed: Apr. 15, 2005

(30) Foreign Application Priority Data
May 8, 2004 (CN) 200410027195.5

(51) Int. Cl. G06F 15/177

(52) U.S. Cl. 713/2; 713/1

(57) ABSTRACT

A method and system for automatically initializing a SATA controller, which is used to set up a specified SATA port as enable or disable, the method includes: inputting a value of the specified SATA port to an interface; automatically identifying ICH south bridge and the SATA controller by searching a table of vendor ID and device ID of the ICH south bridge and the SATA controller, an identified result being achieved; according to the identified result automatically rewriting values that the SATA controller exists in memory to enable the SATA controller; automatically setting values of offset address in a BIOS to achieve initialization of the SATA controller. The system stores a program of automatically initializing the SATA controller therein.

### BACKGROUND OF THE INVENTION

1. Field of the Invention

The present invention relates to a method and system for initializing SATA controllers, and particularly to a method and system for automatically initializing a SATA controller.

2. General Background

Conventionally, Intel's ICH5 (I/O CONTROLLER HUB) series south bridge chipset supports 2×SATA (Serial Advanced Technology Architecture) ports, and ICH6 series south bridge chipset is the successor to the ICH5, featuring support for 4×SATA ports. An SATA controller is within the ICH series south bridge chipset. The ICH5 and ICH6 south bridge chipset each has a vendor ID and a device ID stored therein. After a computer is powered on, these IDs are stored in a storage area of a BIOS chipset.

One known technique for initializing the SATA controller is manual operation according to the specification of the INTEL. Computer manufacturers run the initialization program under DOS (Disk Operating System). The method of manual initializing the ICH6 series SATA controller includes: executing “RU.exe” under DOS; pressing the keyboard combination “Alt+T” and selecting the “List PCI Device”; selecting “Intel Bridge, DEV#=1F, Fun#=00”, pressing ENTER, then pressing “alt+7”, reading the value stored in the address from f0h to f3h as the base address, the address of the ICH6 series SATA controller being offset 3418h from the base address; entering the address then pressing ENTER; setting the second bit of the value of the address to zero; pressing “alt+T”, selecting “list PCI Device”, and selecting the “Intel XXXX8086 2652”, entering the values as below in turn and pressing ENTER after each value:

(A0h)=18, (A4h)=64, (A0h)=40, (A6h)=22, (A0h)=18, (92h)=00, (A0h)=1 C, (A6h)=04, (92h)=**;

** represents the specified port, for example:

Port 0 - - - 01, Port 1 - - - 02, Port 2 - - - 04, Port 3 - - - 08. An oscillograph is connected to a cable of the SATA port, then a profile is displayed on a screen.

However, the initial procedure is manually executed, which is unduly cumbersome and time-consuming. Mistakes are often made during manipulation. Moreover, it is rather inconvenient and laborious to initial SATA controller by handwork.

### SUMMARY

What is needed is a method for automatically initializing a SATA controller.

What is also needed is a system for automatically initializing a SATA controller.

A method for automatically initializing the SATA controller includes: inputting a value of a specified SATA port to an interface; automatically identifying the ICH south bridge and the SATA controller by searching a table of vendor ID and device ID of the ICH south bridge and the SATA controller; according to the identified result, automatically rewriting the data in the location which the SATA controller exists in BIOS to enable the SATA controller; automatically setting values of offset in the BIOS to achieve the initialization of the SATA controller.

A system for automatically initializing a SATA controller includes an interface for displaying the process of the initializing the SATA controller; an input device for inputting a value of a specified SATA port on the interface; a south bridge chipset comprising a SATA controller, the south bridge chipset and the SATA controller have a vender ID and a device ID; a BIOS chipset with the vender ID and the device ID stored therein; and a motherboard with the south bridge chipset and the BIOS chipset mounted thereon. The system stores a program therein for causing a computer to carry out the method of initializing the SATA controller.

It is of advantage that initializing procedure is executed automatically, so manual operation errors are decreased and operational efficiency is improved.

Other objects, advantages and novel features will become more apparent from the following detailed description when taken in conjunction with the accompanying drawings, in which:

### BRIEF DESCRIPTION OF THE DRAWINGS

FIG. 1 is a flow diagram of a method for initializing a SATA controller in accordance with a preferred embodiment of the present invention.

### DETAILED DESCRIPTION OF THE INVENTION

A system for automatically initializing a SATA controller in accordance with a preferred embodiment of the present invention includes an interface, an input device, a motherboard, a south bridge chipset, a SATA controller, and a BIOS chipset. The SATA controller is integrated in the south bridge chipset which is mounted on the motherboard. The input device inputs a port value of a specified SATA to the interface which arranges window to display the process of initializing the SATA controller. A program of initializing the SATA controller is stored in the system.

Following is an illustration of initializing an ICH6 SATA controller to describe the process of initializing a SATA controller.

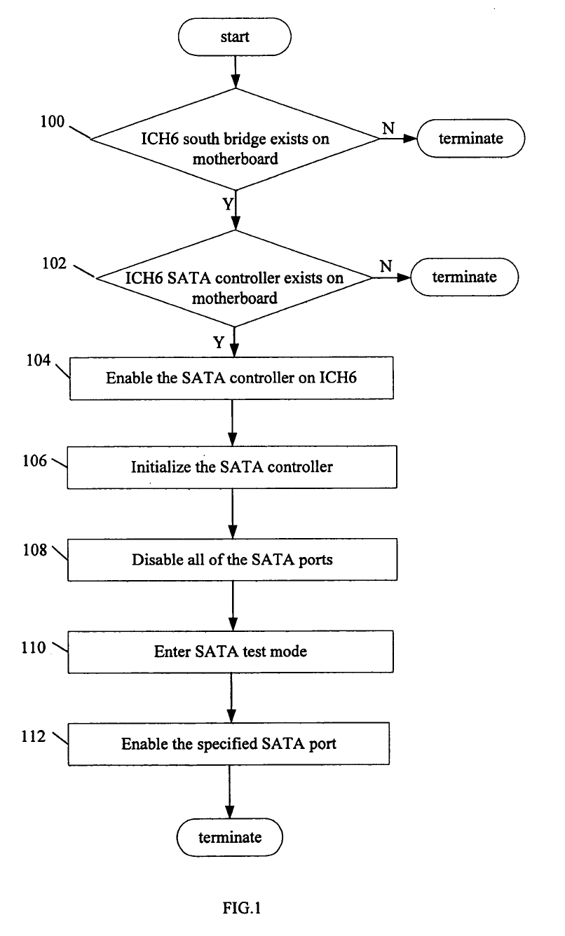

Referring to FIG. 1, a flow diagram of a method for initializing a SATA controller is disclosed. The method includes the following steps.

Step 100: judging whether an ICH6 south bridge chipset exists on the motherboard, if a positive judgment is made, the program goes to step 102, if a negative judgment is made, the program is terminated; a program of the present embodiment setting a table of vender ID and device ID of the ICH6 south bridge chipset, firstly searching whether a vender ID and device ID in the BIOS is same with the IDs in the table, if the result is positive, the motherboard supports the ICH6 south bridge chipset; if the result is negative, “the ICH6 south bridge chipset is not found” may be displayed on the interface.

Step 102: judging whether an ICH6 SATA controller exists in the south bridge chipset, if a positive judgment is made, the program goes to step 104, if a negative judgment is made, the program is terminated; the program of the present embodiment also setting a table of vender ID and device ID of the ICH6 SATA controller, firstly searching whether a vender ID and device ID in the BIOS is same with the IDs in the table, if the result is positive, the motherboard supports the ICH6 SATA controller; if the result is negative, “the ICH6 SATA controller is not found” may be displayed on the interface. The table of the vender ID and device ID of the south bridge chipset and the SATA controller may be in the form as follows:

| | vender ID and device ID |
|---|---|
| South bridge chipset | |
| Desktop ICH6 series | 8086/2640 |
| Notebook ICH6 series | 8086/2641 |
| SATA controller | |
| ICH6 SATA controller | 8086/2651 |
| ICH6R SATA controller | 8086/2652 |
| ICH6M SATA controller | 8086/2653 |

Step 104: enabling SATA controller. The method of the present embodiment automatically reads the values of the first offset address F0h, F1h, F2h, F3h which are addresses of the south bridge chipset in the BIOS as the first base address; the second base address is obtained by replacing the last three bits of the first base address by 000h, the address of the SATA controller in memory is obtained by adding the second address on the second offset 3418h, then the second bit of the address of the SATA controller in memory is set to zero to enable the SATA controller.

Step 106: initializing the SATA controller. Set values of offset address (A0h, A4h, A0h, A6h) of the SATA controller in the BIOS. The values of A0h, A4h, A0h, A6h may be 18, 64, 40, 22.

Step 108, disabling all of the SATA ports. Just set values of the offset address 92h to 00.

Step 110: entering SATA test mode. Reset the values of the offset addresses A0h and A6h, (A0h)=1C, (A6h)=04.

Step 112: enabling the specified SATA port. Reset values of the offset address 92h, the values are corresponding with the specified SATA port, then terminate the program. In the steps 102 and 108, the values of the offset address 92h control the enablement or disablement of the ports of the SATA controller, the states of the SATA ports may be follows:

| Values of the offset | |
|---|---|
| address 92h | State of the SATA port |
| 00 | Disable all ports |
| 01 | Enable SATA port 1 |
| 02 | Enable SATA port 2 |
| 04 | Enable SATA port 3 |
| 08 | Enable SATA port 4 |

The program of initializing the SATA controller is implemented under DOS. Firstly input the value (1, 2, 3, 4) of a specified port from an input device (e.g. a keyboard). The program may search the ICH6 south bridge chipset and the ICH6 SATA controller, read the values of the first offset addresses F0h to F3h as the base address. Following are the values read from the BIOS:

| Offset address | Value |
|---|---|
| F0 | 01 |
| F1 | C0 |
| F2 | D1 |
| F3 | FE |

The second base address is obtained by replacing the last three bits of the first base address FED1C001h with 000h, the second base address plus the second offset 3418h is FED1F418, i.e. the address of the ICH6 in the BIOS. The second bits of the values stored in the address FED1F418h is set to zero, that is:
(00h)=65h=0110 0101b, the second bit is set to zero, then 0110 0001b=61h
(02h)=0Fh=0000 1111b, the second bit is set to zero, then 0000 1011b=0Bh
Then automatically execute steps 106 to 112 to finish initializing the SATA controller.

The method and system of the present embodiment can also be provided to initialize a ICH6R SATA controller or a ICH6M SATA controller, the difference between the initializing program of the ICH6R or ICH6M with the ICH6 SATA controller is in the steps 102 to 104. In the step 102, the ICH6R or ICH6M initializing program may find vender ID and device ID of the ICH6R or ICH6M, in the step 104, the program automatically reads the values of the first offset F0h, F1h, F2h, F3h which is the address of the ICH6R or ICH6M south bridge chipset in BIOS as the first base address. The other steps are same with the program of initializing the ICH6 SATA controller.

The method and system of the present invention can also be provided to initialize the other series south bridge chipset, such as ICH5 south bridge chipset. However, in the steps 100 and 102, the initializing program of the ICH5 and ICH6 south bridge chipset differs in the vender ID and device ID; In the step 104, only read the values of the first offset F2h which is the address of the south bridge chipset in BIOS, and set the second bit of the values to zero to enable the SATA controller. In the steps 106 to 112, the values of the offset address are same between the program of initializing the ICH5 and ICH6 SATA controller.

It is to be understood, however, that even though numerous characteristics and advantages of the present embodiment have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A method for automatically initializing a Serial Advanced Technology Architecture (SATA) controller comprising steps of:
inputting a value of a specified SATA port to an interface;
automatically identifying ICH south bridge and the SATA controller by searching a table of vendor ID and device ID of the ICH south bridge and the SATA controller, an identified result being achieved;
according to the identified result automatically rewriting values that the SATA controller exists in memory to enable the SATA controller;
automatically setting values of offset address in a BIOS to achieve initialization of the SATA controller.

2. The method as claimed in claim 1, wherein the automatically setting step comprises steps of:
initializing the SATA controller;
disabling all SATA ports;
entering SATA test mode;
enabling a specified SATA port.

3. The method as claimed in claim 1, wherein the method is implemented under DOS.

4. The method as claimed in claim 1, wherein the automatically identifying step comprises:
judging whether an ICH south bridge chipset exists on a motherboard; and
judging whether an ICH SATA controller exists in the south bridge chipset.

5. A system for storing a program therein for causing a computer to automatically carry out the method of initializing the SATA controller, the system comprising:
an interface for displaying the program of the initializing the SATA controller;
an input device for inputting a value of a specified SATA port to the interface;
a south bridge chipset, the south bridge chipset comprising a SATA controller, the south bridge chipset and the SATA controller having a vender ID and a device ID;
a BIOS chipset, the vender ID and the device ID stored therein;
a motherboard, the south bridge chipset and the BIOS chipset are mounted thereon.

6. The system as claimed in claim 5, wherein the program is implemented under DOS.

7. A method for automatically initializing use of a Serial Advanced Technology Architecture (SATA) port of a system, comprising steps of:
identifying a SATA controller of said system by which said SATA port is controlled to enable for said use;
enabling said SATA controller by means of automatically adjusting values retrieved from said system which are predetermined as enabling inputs of said SATA controller;
initializing said SATA controller;
resetting said SATA port for testing; and
enabling said SATA port so as to initialize said use of said SATA port.

8. The method as claimed in claim 7, wherein a table of vendor ID and device ID of said SATA controller is created to contribute to said identifying of said SATA controller in said identifying step.

9. The method as claimed in claim 7, further comprising the step of initially disabling said SATA port before said resetting step.
